(19) United States
(12) Patent Application Publication
(10) Pub. No.: US 2020/0081290 A1
(43) Pub. Date: Mar. 12, 2020

(54) LIQUID CRYSTAL DISPLAY PANEL AND LIQUID CRYSTAL DISPLAY DEVICE

(71) Applicant: Wuhan China Star Optoelectronics Technology Co., Ltd., Wuhan, Hubei (CN)

(72) Inventors: Zuomin LIAO, Wuhan, Hubei (CN); Jinfang WU, Wuhan, Hubei (CN)

(21) Appl. No.: 15/747,389

(22) PCT Filed: Nov. 29, 2017
(86) PCT No.: PCT/CN2017/113529

§ 371 Date: Jan. 24, 2018

(30) Foreign Application Priority Data
Nov. 22, 2017 (CN) 201711175834.6

(51) Int. Cl. G02F 1/1335; G02F 1/1343

(52) U.S. Cl. CPC G02F 1/133512; G02F 1/133514; G02F 2001/133357; G02F 1/134309; G02F 1/133602

(57) ABSTRACT

The disclosure discloses a liquid crystal display panel including a thin film transistor (TFT) substrate, a CF substrate disposed opposite to the TFT substrate, and a liquid crystal layer between the TFT substrate and the CF substrate, at least a base substrate, a TFT layer, and a pixel electrode layer is arranged on the TFT substrate, a light-shielding layer configured to cover each of the thin film transistors disposed between the base substrate and the TFT layer of the TFT substrate, and a color filter layer is disposed on the CF substrate. The disclosure also discloses a corresponding liquid crystal display device. In the embodiment, the backlight module is disposed outside the CF substrate, and the light-shielding layer is disposed in the TFT substrate to reduce the thickness of the liquid crystal display panel and the frame width, and the process is simple, and the cost is low.

### RELATED APPLICATIONS

The present application is a National Phase of International Application Number PCT/CN2017/113529, filed Nov. 29, 2017, and claims the priority of China Application No. 201711175834.6, filed Nov. 22, 2017.

### FIELD OF THE DISCLOSURE

The disclosure relates to the field of display, and in particular to a liquid crystal display panel and a liquid crystal display device.

### BACKGROUND

Liquid crystal display (LCD) has great market competition advantages due to its advantages such as mature technology, low cost, and capable of realizing high pixels per inch (PPI) and narrow frame. With the development of technology, the market demand now shows that the overall thickness of the panel needs to be extremely thin and the frame needs to be extremely narrow. At present, the ultrathin thickness is mainly realized through the thinning of the glass and the thinning of the film layer of the module body. The extremely narrow frame is mainly achieved by a gate on array (GOA), a chip on film (COF), or other integrated technologies.

However, there are still many shortcomings in these solutions. For example, in the prior art, the structure of the liquid crystal display panel is typically a color filter glass (CF Glass) substrate on the thin film transistor glass (TFT Glass) substrate, the backlight assembly disposed under the TFT Glass substrate, a single-layer COF Structure, this design is conducive to a very narrow border but the module thickness larger; in another case, you can use double-layer COF structure, this design is conducive to narrow down the frame and thin the module thickness, but the cost is high and the process is complex, which is not suitable for mass production.

### SUMMARY

A technical problem to be solved by the disclosure is to provide a liquid crystal display panel and a liquid crystal display device, in which a backlight module is disposed outside the CF substrate and a light-shielding layer is disposed in the TFT substrate, so as to reduce the thickness of the liquid crystal display panel and the width of the frame, and the process is simple, and the cost is lower.

In order to solve the above technical problem, an aspect of an embodiment of the disclosure provides a liquid crystal display panel, which includes a TFT substrate, a CF substrate disposed opposite to the TFT substrate, and a liquid crystal layer between the TFT substrate and the CF substrate;

at least a base substrate, a thin film transistor layer, and a pixel electrode layer is arranged on the TFT substrate, a light-shielding layer is disposed between the base substrate and the thin film transistor layer of the TFT substrate and is configured to cover each thin film transistor, and a color filter layer is disposed on the CF substrate.

The thin film transistor layer at least includes an active layer, a gate, a source, and a drain; the light-shielding layer is disposed between the base substrate and the active layer and faces and covers the gate, the source, and the drain.

The light-shielding layer includes:

a first light-shielding layer disposed between the base substrate and the active layer and facing and covering the drain;

a second light-shielding layer disposed between the base substrate and the active layer and facing and covering the source; and

a third light-shielding layer disposed on an upper side of the gate and facing and covering the gate.

The light-shielding layer is made of a low reflection material.

The TFT substrate includes:

the base substrate;

a first insulating layer bonded to a lower surface of the base substrate;

the active layer is disposed on a lower surface of the first insulating layer;

a second insulating layer disposed on a lower surface of the active layer;

the gate electrode is disposed on a lower surface of the second insulating layer;

a third insulating layer disposed on a lower surface of the gate;

the source electrode is disposed on a lower surface of the third insulating layer and is connected to the active layer through the third insulating layer;

the drain is disposed on a lower surface of the third insulating layer and is connected to the active layer through the third insulating layer;

a planarization layer disposed on a lower surface of the third insulating layer and covering the source and the drain, and a source contact hole disposed on the planarization layer;

a common electrode layer disposed on a lower surface of the planarization layer;

a passivation layer disposed on a lower surface of the common electrode layer; wherein the source contact hole passes through the common electrode layer and the passivation layer; and

a pixel electrode layer disposed on a lower surface of the passivation layer and connected to the source through an inner surface of the source contact hole.

The CF substrate includes:

a base substrate;

a black matrix layer disposed on the base substrate;

a color filter layer disposed on the base substrate and the black matrix layer; and

a protective layer disposed on the color filter layer.

Accordingly, an embodiment of the disclosure further provides a liquid crystal display device, including at least a liquid crystal cell and a backlight module, the liquid crystal cell includes a TFT substrate, a CF substrate disposed opposite to the TFT substrate, and a liquid crystal layer between the TFT substrate and the CF substrate, and the backlight module is located outside the CF substrate of the liquid crystal cell;

at least a base substrate, a thin film transistor layer, and a pixel electrode layer is arranged on the TFT substrate, a light-shielding layer is disposed between the base substrate and the thin film transistor layer of the TFT substrate and is configured to cover each thin film transistor, and a color filter layer is disposed on the CF substrate.

The thin film transistor layer at least includes an active layer, a gate, a source, and a drain; the light-shielding layer is disposed between the base substrate and the active layer and faces and covers the gate, the source, and the drain.

The light-shielding layer includes:

a first light-shielding layer disposed between the base substrate and the active layer and facing and covering the drain;

a second light-shielding layer disposed between the base substrate and the active layer and facing and covering the source; and

a third light-shielding layer disposed on an upper side of the gate and facing and covering the gate.

The light-shielding layer is made of a low reflection material.

The TFT substrate includes:

the base substrate;

a first insulating layer bonded to a lower surface of the base substrate;

the active layer is disposed on a lower surface of the first insulating layer;

a second insulating layer disposed on a lower surface of the active layer;

the gate electrode is disposed on a lower surface of the second insulating layer;

a third insulating layer disposed on a lower surface of the gate;

the source electrode is disposed on a lower surface of the third insulating layer and is connected to the active layer through the third insulating layer;

the drain is disposed on a lower surface of the third insulating layer and is connected to the active layer through the third insulating layer;

a planarization layer disposed on a lower surface of the third insulating layer and covering the source and the drain, and a source contact hole disposed on the planarization layer;

a common electrode layer disposed on a lower surface of the planarization layer;

a passivation layer disposed on a lower surface of the common electrode layer; wherein the source contact hole passes through the common electrode layer and the passivation layer; and

a pixel electrode layer disposed on a lower surface of the passivation layer and connected to the source through an inner surface of the source contact hole.

The CF substrate includes:

a base substrate;

a black matrix layer disposed on the base substrate;

a color filter layer disposed on the base substrate and the black matrix layer; and

a protective layer disposed on the color filter layer.

The embodiment of the has the following advantageous effects:

The liquid crystal display panel and the liquid crystal display device provided by the disclosure can adopt a single-layer COF structure by disposing the backlight module outside the CF substrate so as to reduce the thickness of the liquid crystal display panel and the width of the frame, and the process is simple, and the cost is lower, thereby having greater practicality and producibility;

In addition, disposing the light-shielding layer in the TFT substrate can prevent display defects caused by the reflection of the TFT side metal under the action of the external light source, thereby ensuring the display effect.

### BRIEF DESCRIPTION OF THE DRAWINGS

In order to illustrate technical schemes of the disclosure or the prior art more clearly, the following section briefly introduces drawings used to describe the embodiments and prior art. Obviously, the drawing in the following descriptions is just some embodiments of the disclosure. The ordinary person in the related art can acquire the other drawings according to these drawings without offering creative effort.

FIG. 1 is a schematic structural view of an embodiment of a liquid crystal display device provided by the disclosure; and

FIG. 2 is a schematic structural view of another embodiment of a liquid crystal display device provided by the disclosure.

### DETAILED DESCRIPTION OF PREFERRED EMBODIMENTS

The following sections offer a clear, complete description of this disclosure in combination with the embodiments and accompanying drawings. Obviously, the embodiments described herein are only a part of, but not all of the embodiments of this disclosure. In view of the embodiments described herein, any other embodiment obtained by those of ordinary skill in the art skilled in this art without offering creative effort is included in a scope claimed by this disclosure.

Here, it should be further noted that in order to prevent the present invention to be obscured due to unnecessary details, only apparatus structures and/or processing steps closely related to the solution according to the present invention are shown in the accompanying drawings, while other details having little relations are omitted.

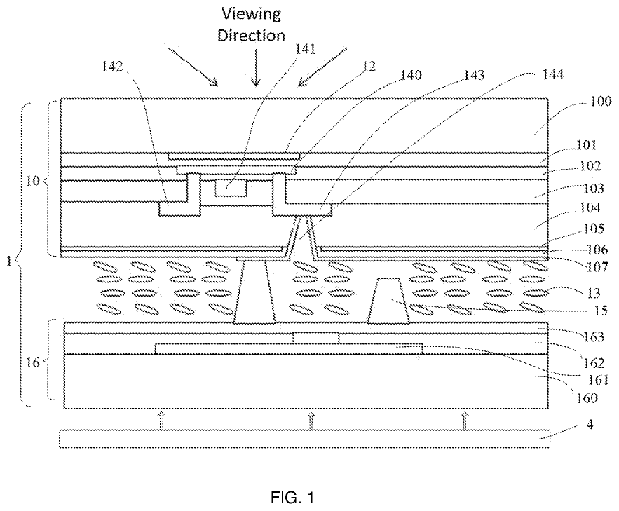

As shown in FIG. 1, which is a schematic structural view of an embodiment of a liquid crystal display device provided by the disclosure. In this embodiment, the liquid crystal display device includes at least one liquid crystal cell and a backlight module 4, and the liquid crystal cell 1 includes a TFT substrate 10, a CF substrate 16, and a liquid crystal layer 13 between the TFT substrate 10 and the CF substrate 16. The backlight module 4 is located outside the CF substrate 16 of the liquid crystal cell.

At least a base substrate 100, a thin film transistor layer, and a pixel electrode layer is arranged on the TFT substrate 10, a light-shielding layer 12 is disposed between the base substrate 100 and the thin film transistor layer of the TFT substrate and is configured to cover each thin film transistor, and a color filter layer is disposed on the CF substrate.

The thin film transistor layer includes at least an active layer, a gate, a source, and a drain. The light-shielding layer 12 is disposed between the base substrate and the active layer and faces and covers the gate, the source, and the drain. The light-shielding layer is made of a low-reflection material, so that the display defects can be prevented from the light reflection of the thin film transistor side metal (i.e., the metal of the gate, the source, and the drain) under the action of an external light source.

Specifically, in one embodiment, the TFT substrate 10 includes:

the base substrate 100, which may be a glass substrate or a PI (polyimide) substrate;

the first insulating layer 101, bonded to a lower surface of the base substrate 100 of the TFT substrate 10, which can be made of a material such as SiNx or SiOx. It is understood that the lower surface refers to a side close to the liquid crystal layer 13;

the active layer 140, disposed on a lower surface of the first insulating layer 101, which can be made of amorphous silicon, IGZO or polysilicon;

the second insulating layer 102, disposed on a lower surface of the active layer 140 and may be made of a material such as SiNx or SiOx;

the gate 141, disposed on a lower surface of the second insulating layer 102;

the third insulating layer 103, disposed on the lower surface of the gate 141, which may be made of a material such as SiNx or SiOx;

the drain electrode 142 disposed on a lower surface of the third insulating layer 103 and connected to the active layer through the third insulating layer 140;

the source electrode 143 disposed on a lower surface of the third insulating layer 103 and connected to the active layer 140 through the third insulating layer 130;

a planarization layer 104 disposed on a lower surface of the third insulation layer 103 and covering the source 143 and the drain 142, and a source contact hole 144 formed on the planarization layer 104;

a common electrode layer 105 disposed on a lower surface of the planarization layer 104 and may be an ITO (Indium Tin Oxide) material;

a passivation layer 106 disposed on a lower surface of the common electrode layer 105, the source contact hole 144 penetrating the common electrode layer 105 and the passivation layer 106; and

a pixel electrode layer 107 disposed on a lower surface of the passivation layer 106 and connected to the source 143 through an inner surface of the source contact hole 144, and the pixel electrode layer 107 may be an ITO material.

In this embodiment, the light-shielding layer 12 is disposed between the base substrate 100 and the first insulating layer 101 and faces and covers the gate 141, the source 143, and the drain 142.

It can be understood that in other embodiments, the light-shielding layer 12 may also be disposed between the first insulating layer 101 and the active layer 140 and faces and covers the gate 141, the source 143, and the drain 142, which can achieve similar effects.

In FIG. 1, the CF substrate 16 further includes:

a base substrate 160, which may be a glass substrate or a PI substrate;

a black matrix layer 161 disposed on the base substrate 160 of the CF substrate 16, it can be understood that here the black matrix layer 161 is disposed on the base substrate 160 means that is disposed on a side surface of the base substrate 160 adjacent to the liquid crystal layer 3;

a color filter layer 162 disposed on the base substrate 160 of the CF substrate 16 and the black matrix layer 161 and including a red color filter, a blue color filter, and a green color filter; and

a protective layer 163 disposed on the color filter layer 162.

A plurality of support posts 15 is further included in the liquid crystal layer 3.

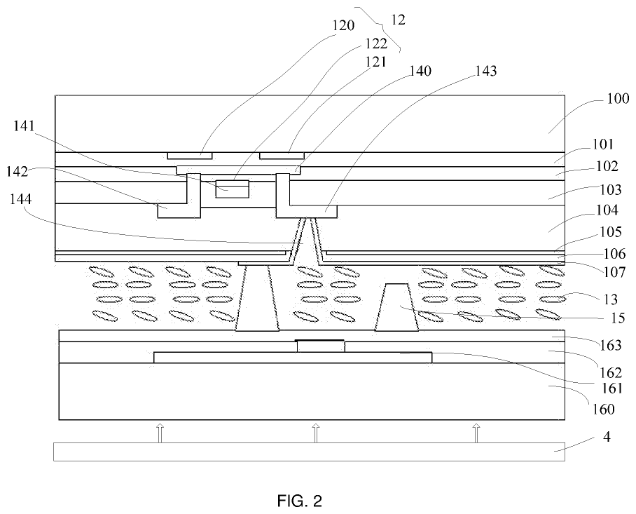

As shown in FIG. 2, a structural schematic view of another embodiment of a liquid crystal display device according to the disclosure is shown. In this embodiment, the difference from the structure in the embodiment shown in FIG. 1 lies in that, the light-shielding layer 12 includes:

a first light-shielding layer 120 is disposed between the base substrate 100 and the active layer 140 and faces and covers the drain 142; in FIG. 2, the first light-shielding layer 120 is disposed between the base substrate 100 and the first insulating layer 101; it can be understood that, in other embodiments, it may also be disposed between the first insulating layer 101 and the active layer 140;

a second light-shielding layer 121 disposed between the base substrate 100 and the active layer 140 and facing and covering the source electrode 143; in FIG. 2, the second light-shielding layer 121 is disposed between the base substrate 100 and the first insulating layer 101, and it can be understood that, in other embodiments, it may be disposed between the first insulating layer 101 and the active layer 140;

a third light-shielding layer 122 disposed on an upper side of the gate 141 and facing and covering the gate 141.

For other structures, reference may be made to the foregoing description of FIG. 2, which are not described herein.

The embodiment of the has the following advantageous effects:

The liquid crystal display panel and the liquid crystal display device provided by the disclosure can adopt a single-layer COF structure by disposing the backlight module outside the CF substrate so as to reduce the thickness of the liquid crystal display panel and the width of the frame, and the process is simple, and the cost is lower, thereby having greater practicality and producibility;

simultaneously, it is not limited to adopting single-layer COF, other COF structures may also be adopted, and the application is diversified.

In addition, disposing the light-shielding layer in the TFT substrate can prevent display defects caused by the reflection of the TFT side metal under the action of the external light source, thereby ensuring the display effect.

It is to be noted that, in the context, relational terms such as first and second are used only to distinguish an entity or an operation from another entity or another operation without necessarily requiring or implying that such entities or operations have any such actual relationship or sequence. Moreover, terms “include”, “comprise” or any other variant thereof is intended to encompass a non-exclusive inclusion such that processes, methods, articles, or devices that include a series of elements include not only those elements but also those that are not explicitly listed. In the absence of more restrictions, the elements defined by the statement “including a . . . ” do not preclude the presence of additional elements in the process, method, article, or device that includes the elements.

It should be indicated that the present application can also be improved and modified by those skilled in the art without departing from the principle of the present application, and these improvements and modifications also fall within the protection scope of the claims of the present application.

What is claimed is:

1. A liquid crystal display panel, comprising:
a TFT substrate;
a CF substrate disposed opposite to the TFT substrate; and
a liquid crystal layer between the TFT substrate and the CF substrate;
wherein at least a base substrate, a thin film transistor layer, and a pixel electrode layer are arranged on the TFT substrate, a light-shielding layer is disposed between the base substrate and the thin film transistor layer of the TFT substrate and is configured to cover each thin film transistor, and a color filter layer is disposed on the CF substrate.

2. The liquid crystal display panel according to claim 1, wherein the thin film transistor layer at least comprises an active layer, a gate, a source, and a drain; the light-shielding layer is disposed between the base substrate and the active layer and faces and covers the gate, the source, and the drain.

3. The liquid crystal display panel according to claim 2, wherein the light-shielding layer comprises:
a first light-shielding layer disposed between the base substrate and the active layer and facing and covering the drain;
a second light-shielding layer disposed between the base substrate and the active layer and facing and covering the source; and
a third light-shielding layer disposed on an upper side of the gate and facing and covering the gate.

4. The liquid crystal display panel according to claim 3, wherein the TFT substrate comprises:
the base substrate;
a first insulating layer bonded to a lower surface of the base substrate of the TFT substrate;
wherein the active layer is disposed on a lower surface of the first insulating layer;
a second insulating layer disposed on a lower surface of the active layer;
wherein the gate electrode is disposed on a lower surface of the second insulating layer;
a third insulating layer disposed on a lower surface of the gate;
wherein the source electrode is disposed on a lower surface of the third insulating layer and is connected to the active layer through the third insulating layer;
wherein the drain is disposed on the lower surface of the third insulating layer and is connected to the active layer through the third insulating layer;
a planarization layer disposed on the lower surface of the third insulating layer and covering the source and the drain, and a source contact hole disposed on the planarization layer;
a common electrode layer disposed on a lower surface of the planarization layer; and
a passivation layer disposed on a lower surface of the common electrode layer; wherein the source contact hole passes through the common electrode layer and the passivation layer;
wherein the pixel electrode layer is disposed on a lower surface of the passivation layer and is connected to the source through an inner surface of the source contact hole.

5. The liquid crystal display panel according to claim 4, wherein the CF substrate comprises:
a base substrate;
a black matrix layer disposed on the base substrate of the CF substrate;
the color filter layer disposed on the base substrate of the CF substrate and the black matrix layer; and
a protective layer disposed on the color filter layer.

6. The liquid crystal display panel according to claim 2, wherein the light-shielding layer is made of a low reflection material.

7. The liquid crystal display panel according to claim 3, wherein the light-shielding layer is made of a low reflection material.

8. The liquid crystal display panel according to claim 4, wherein the light-shielding layer is made of a low reflection material.

9. The liquid crystal display panel according to claim 5, wherein the light-shielding layer is made of a low reflection material.

10. A liquid crystal display device, comprising:
at least a liquid crystal cell; and
at least a backlight module;
wherein the liquid crystal cell comprises a TFT substrate, a CF substrate disposed opposite to the TFT substrate, and a liquid crystal layer between the TFT substrate and the CF substrate, wherein the backlight module is located outside the CF substrate of the liquid crystal cell;
wherein at least a base substrate, a thin film transistor layer, and a pixel electrode layer are arranged on the TFT substrate, a light-shielding layer is disposed between the base substrate and the thin film transistor layer of the TFT substrate and is configured to cover each thin film transistor, and a color filter layer is disposed on the CF substrate.

11. The liquid crystal display device according to claim 10, wherein the thin film transistor layer at least comprises an active layer, a gate, a source, and a drain; the light-shielding layer is disposed between the base substrate and the active layer and faces and covers the gate, the source, and the drain.

12. The liquid crystal display device according to claim 11, wherein the light-shielding layer comprises:
a first light-shielding layer disposed between the base substrate and the active layer and facing and covering the drain;
a second light-shielding layer disposed between the base substrate and the active layer and facing and covering the source; and
a third light-shielding layer disposed on an upper side of the gate and facing and covering the gate.

13. The liquid crystal display device according to claim 12, wherein the TFT substrate comprises
the base substrate;
a first insulating layer bonded to a lower surface of the base substrate;
wherein the active layer is disposed on a lower surface of the first insulating layer;
a second insulating layer disposed on a lower surface of the active layer;
wherein the gate electrode is disposed on a lower surface of the second insulating layer;
a third insulating layer disposed on a lower surface of the gate;
wherein the source electrode is disposed on a lower surface of the third insulating layer and is connected to the active layer through the third insulating layer;
wherein the drain is disposed on the lower surface of the third insulating layer and is connected to the active layer through the third insulating layer;
a planarization layer disposed on the lower surface of the third insulating layer and covering the source and the drain, and a source contact hole disposed on the planarization layer;
a common electrode layer disposed on a lower surface of the planarization layer;
a passivation layer disposed on a lower surface of the common electrode layer; wherein the source contact hole passes through the common electrode layer and the passivation layer; and
a pixel electrode layer disposed on a lower surface of the passivation layer and connected to the source through an inner surface of the source contact hole.

14. The liquid crystal display device according to claim 13, wherein the CF substrate comprises:
a base substrate;
a black matrix layer disposed on the base substrate;
the color filter layer disposed on the base substrate and the black matrix layer; and
a protective layer disposed on the color filter layer.

15. The liquid crystal display device according to claim 11, wherein the light-shielding layer is made of a low reflection material.

16. The liquid crystal display device according to claim 12, wherein the light-shielding layer is made of a low reflection material.

17. The liquid crystal display device according to claim 13, wherein the light-shielding layer is made of a low reflection material.

18. The liquid crystal display device according to claim 14, wherein the light-shielding layer is made of a low reflection material.
